(19) United States
(12) Patent Application Publication
(10) Pub. No.: US 2010/0124158 A1
(43) Pub. Date: May 20, 2010

(54) HOLOGRAPHY WITH INTERFERENCE REVIVAL

(75) Inventor: Riccardo Leto, Arlington, MA (US)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/273,936

(22) Filed: Nov. 19, 2008

(51) Int. Cl. G11B 7/00

(52) U.S. Cl. 369/112.23; G9B/7

(57) ABSTRACT

An optical system for reading and recording data on a media includes a laser source for generating a laser beam; an optical subsystem for splitting the laser beam into a reference beam and an object beam; and first and second lens for receiving the reference beam and object beam, respectively, and focusing the reference and object beams at a focal point on the media at which the reference beam and object beam interfere with each other. The reference beam and the object beam have first and second optical path lengths defined from the laser source to the focal point of the media. The optical subsystem is positioned so that an optical path length difference between the first and second optical path lengths is substantially equal to an integer multiple of an interference revival period associated with the reference beam and the object beam, the interference revival period associated with peak values of visibility of the interference versus the optical path difference.

### TECHNICAL FIELD

The technical field relates generally to optical systems and, more particularly, to a hologram recording apparatus.

### BACKGROUND

An optical system such as a hologram recording apparatus can include a laser source for emitting an object beam and reference beam, which are radiated onto a hologram-recording media at the same position. The object beam and the reference beam interfere with each other inside the media to form a diffraction pattern or so called microhologram at the irradiation point for recording data on the media.

When the media on which the data is already recorded is irradiated with the reference light, diffracted light (reproducing light) is generated by the microhologram formed in the recording process. The reproducing light includes data superimposed on the object beam in the recording process. Therefore, the recorded signal can be reproduced by receiving the reproducing light with a photo-sensitive element such as a photodiode.

High interference between the signal light and the reference beam, or generally two or more light beams, is important for generating holography. The level of interference between the two or more light beams will depend upon the coherence of the two or more light beams.

In one exemplary configuration, the laser source can be a semiconductor laser diode for emitting the laser beam and reference beam. However, the semiconductor laser diode has the drawback of low coherence due to the multimode associated with the laser beam, and thereby lower interference.

In another exemplary configuration, the laser source of the optical system can be an external cavity laser including a laser diode emitting a laser beam which is collimated by a collimating lens, and radiated onto a reflective diffraction grating so that the laser beam is a single mode beam, thereby having higher coherence. However, a change in the current supplied to the laser diode or generally a change in the diode temperature can result in mode hop, which is a transition between single modes of the laser beam. A conventional external cavity can include an interferometer and detectors for periodically monitoring for the occurrence of mode hop. However, such objects can increase the manufacturing costs of the external cavity laser as well as enlarging the structure.

Hologram recording apparatus can write data on the entire volume of a media such as a disc of 1 mm in thickness. Taking advantage of the bit-by-bit holography method where each single microhologram represents a single data bit and can be made as small in size as the data bits in a Blu-ray disc technology, data can possibly be stored in, for example, 100 layers of a disc. In comparison, data is only stored in two layers of a Blu-ray disc. Despite this potential improvement in storage capacity, hologram recording apparatus have been limited to niche markets such as data storage because of, for example, the high costs associated with the external cavity laser and the complexity of the optical system as discussed above. That is, an optical system including a compact, low cost laser source that could feasibly be made for the general consumer market has not yet been realized.

### SUMMARY

Accordingly, an optical system according to various novel embodiments includes a laser source for generating a laser beam; an optical subsystem for splitting the laser beam into a reference beam and an object beam; and first and second objective lens for receiving the reference beam and object beam, respectively, and focusing the reference and object beams at a focal point on media at which the reference beam and object beam interfere with each other. The reference beam and the object beam have first and second optical path lengths defined from the laser source to the focal point of the media. The optical subsystem is positioned so that an optical path length difference between the first and second optical path lengths is substantially equal to an integer multiple of an interference revival period associated with the reference beam and the object beam. The interference revival period is associated with peak values of visibility of the interference versus the optical path difference.

The laser source can be merely a semiconductor laser diode generating a multimode laser beam. Alternatively, the laser source can be an external cavity laser including a multimode laser diode source for generating a multimode laser beam and a grating for outputting a single mode of the light associated with the laser beam.

An optical system according to the various novel embodiments can implement a hologram recording apparatus which can write data on the entire volume of a media at a lower cost due to, for example, use of a semiconductor laser diode as the laser source, or a lower cost external cavity laser.

### BRIEF DESCRIPTION OF THE DRAWINGS

FIG. 1 is a schematic diagram of an exemplary Michelson interferometer for generating two light beams.

FIGS. 2A-2B are illustrations of exemplary interference fringes for different angles and period created by interference of the two light beams in the sensor plane.

FIG. 2C is a schematic diagram of overlapping beams.

FIG. 3 is a graph representing the visibility of the interference fringes versus path difference of the travel of two light beams.

FIG. 4 is an illustration of interference revival.

FIG. 5 is a schematic diagram illustrating an exemplary laser source of an optical system according to an exemplary embodiment.

FIG. 6 is a schematic diagram illustrating an optical system according to the exemplary embodiment.

FIG. 7 is a schematic diagram illustrating an optical system according to another exemplary embodiment.

FIG. 8 is a schematic diagram illustrating an optical system according to another exemplary embodiment.

FIGS. 9A-9C are schematic diagrams illustrating the variable path difference caused by movement of an optical element of the optical system according to the exemplary embodiments.

FIGS. 9D-9I are schematic diagrams illustrating the optical system according to the exemplary embodiments.

FIG. 10 is a schematic diagram illustrating an optical system according to another exemplary embodiment.

FIG. 11 is a schematic diagram of an external cavity laser of the optical system of FIG. 10.

FIG. 12 is an illustration of the interference revival for the external cavity laser.

### DETAILED DESCRIPTION

Various embodiments of an optical system utilizing holography to read and/or record data on a media will be discussed. The optical system reads and/or records data by generating two or more laser beams which generate interference at the media. The optical system can utilize an interference revival effect so that data is successively read from the media and/or recorded on the media even if a path difference between the two or more laser beams is greater than a coherence length of the two or more laser beams. The terms coherence and interference revival will be introduced below.

The concept of coherence is linked to a phase relationship between two points of an optical field separated either in time or space. The optical field is generated by an optical source of some finite dimension. That is, the optical field generally includes a large amount of atoms, each of which can be considered as a photon source. Inside a laser source there is always a high degree of phase correlation between the photons emitted by two atoms of the active region because the emission is mainly stimulated by other photons. Nonetheless, the correlation decreases with distance and time. The coherence length is the extent in space over which the electric field remains correlated or over which the field phase can be predicted. The coherence time is the time needed by a wavetrain to travel a distance equal to the coherence length.

The coherence length is proportional to the coherence time by the speed of light in a vacuum. On the other hand the coherence of a source is tightly linked to the source frequency bandwidth. For example, when the electric field emitted from the source is envisioned as the superposition of wavetrains with a certain duration, the very finite nature in time of these wavetrains is responsible for their infinite spectrum. The bandwidth of this spectrum is inversely proportional to the coherence time, which is the duration of the wavetrain. The proportionality constant depends on the shape of the wavetrain and on the criterion chosen to define the bandwidth, but the above is a general principle that applies to any source. Accordingly, the coherence of a laser source is an indication of the laser bandwidth.

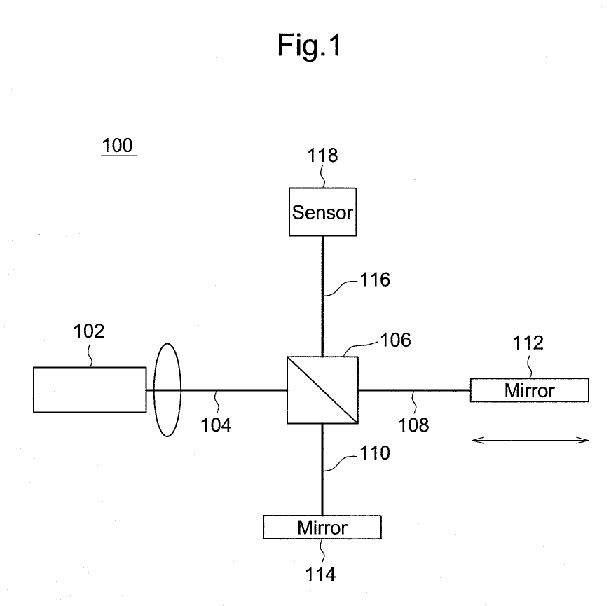

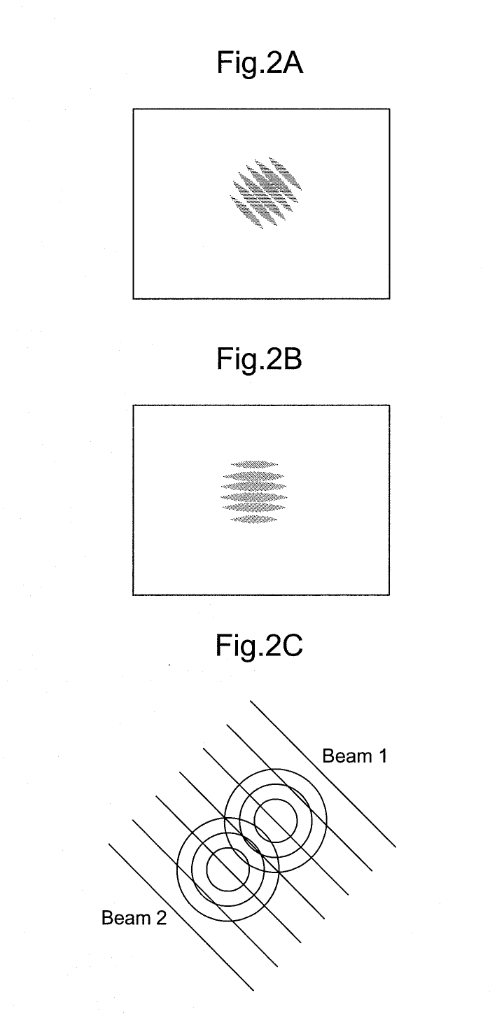

The coherence of a laser source can be measured by a Michelson interferometer such as the exemplary Michelson interferometer 100 shown in FIG. 1. The Michelson interferometer 100 includes a laser source 102 for generating a laser beam 104 and a beam separator 106 for separating the laser beam into two beams 108, 110 that walk different paths. The interferometer 100 also includes first and second mirrors 112, 114 for reflecting the two beams 108, 110 back to the beam separator 106 to be rejoined. The rejoined beams are reflected by the separator 106 and the reflected beam 116 is received at a sensor 118. The phase difference between the two beams 108, 110 is proportional to the path difference if it is smaller or comparable to the coherence length. Otherwise the phase of the two beams 108, 110 becomes uncorrelated. FIGS. 2A-2B show the interferences in the plane of the sensor 118. The interference creates interference fringes that become very visible when the phases of the two beams are correlated, that is, when the path difference is smaller than the coherence length. The interference fringes on the sensor plane have an angle and period linked to the mutual position of the two beams 108, 110. These beams 108, 110 can be slightly misaligned in order to form fringes clearly visible. The angle of the fringes is normal to the axis joining the two beams 108, 110 and the fringe period is inversely proportional to the beam separation. That is, the more the two beams 108, 110 overlap the larger the fringes will be until only one large fringe is visible. An example of overlapping beams is shown in FIG. 2C.

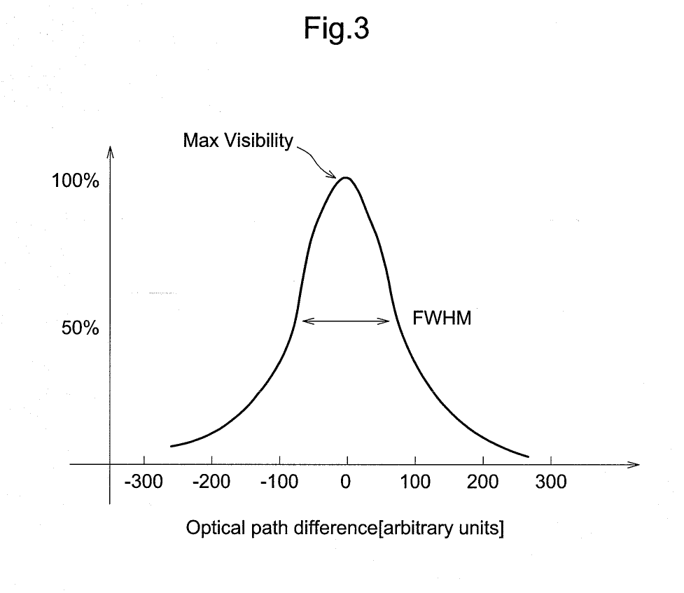

A quantitative measure of the quality of the fringes in an interference pattern can be expressed by visibility, which is a measure of the degree of coherence of the two beams in the Michelson interferometer 100. The visibility function can be measured by moving one arm (or one mirror) of the interferometer 100. The resulting visibility function is the bell shaped curve shown in FIG. 3. The visibility is greatest when the path difference between the two beams is zero and degrades afterwards. Thus, a measure of the coherence length, which will be referred to as Full Width at Half Maximum (FWHM), can be defined as the distance traveled to reduce the visibility by 50% from its greatest value.

Thus, to ensure the interference of the two or more beams inside the media, the coherence length should be larger than an optical path difference in all operating conditions. However, for an optical system using the semiconductor laser diode, the coherence length will be very short. For example, the laser diode currently used in Blu-ray or DVD recording has a short coherence length that is usually less than 600 micrometers, which is not sufficiently long enough to provide a feasible optical system.

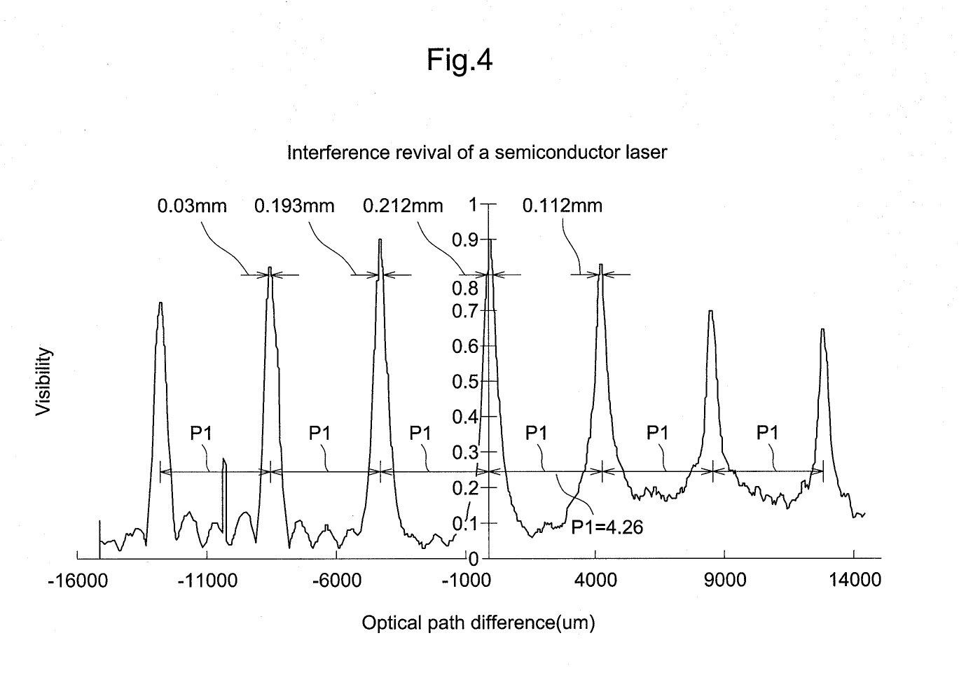

An effect referred to here as interference revival observed when the path difference is much higher than the coherence length and the laser is a multimode source will be introduced. In a Michelson interferometer setup, increasing the path difference steadily decreases the visibility of the fringes until no fringes are visible. However, after a travel of a few mm there will be again fringes forming on the sensor plane. This effect is the interference revival. As shown in FIG. 4, the fringe visibility, which is a measure of the degree of coherence, of a laser diode used for Blu-ray media undergoes periodic revivals with a constant step. The constant step will be referred to here as the interference revival period.

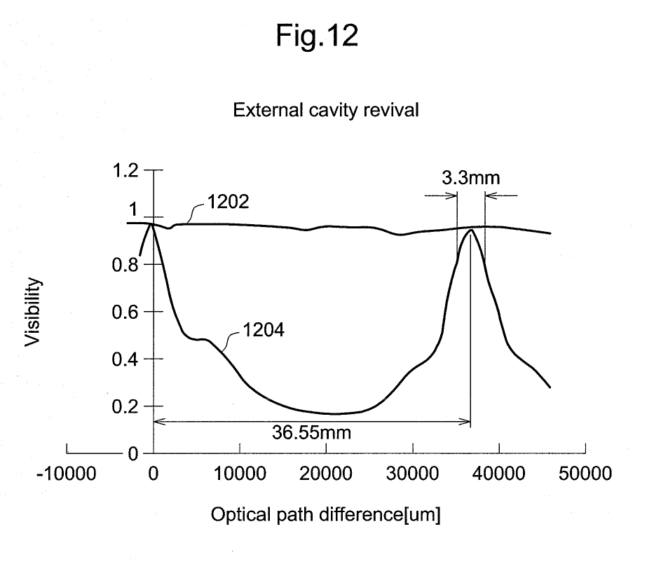

The coherence region is the width of the peak at the minimum allowed visibility. The size of the coherence region in any revival peak will be referred to here as the Peak Coherence Length (PCL). For example, the PCL of the laser diode shown in FIG. 4 is as large as approximately 0.212 mm. In comparison, the PCL of the external cavity revival shown in FIG. 12 is approximately 3.3 mm. Generally, the PCL of the semiconductor laser diode is always much smaller than the PCL of an external cavity laser.

An optical system, according to various embodiments, utilizes the periodic revival to permit the optical path difference to be greater than the short coherence length of, for example, Blu-ray or DVD laser light. Generally, the optical path difference between the two beams when focused in the mid layer can be set at substantially the interference revival period (or at an integer multiplier).

The holographic media should allow permanent refraction index changes depending on the intensity of the electric field of the light so that the holograms can be recorded. Data reading can be performed using the same light at lower intensity to avoid overwriting and observing the reflected light.

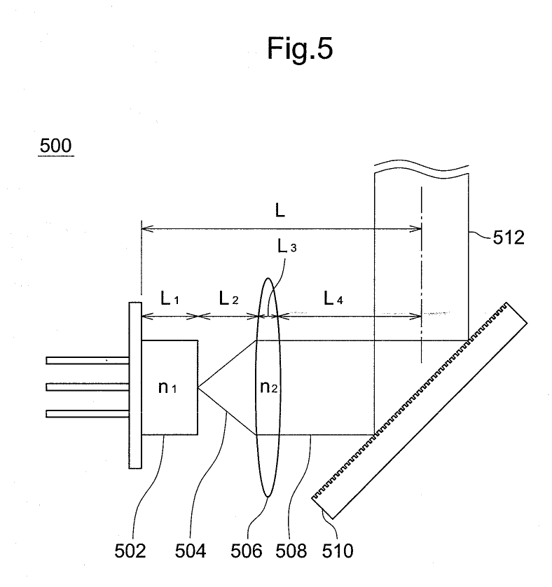

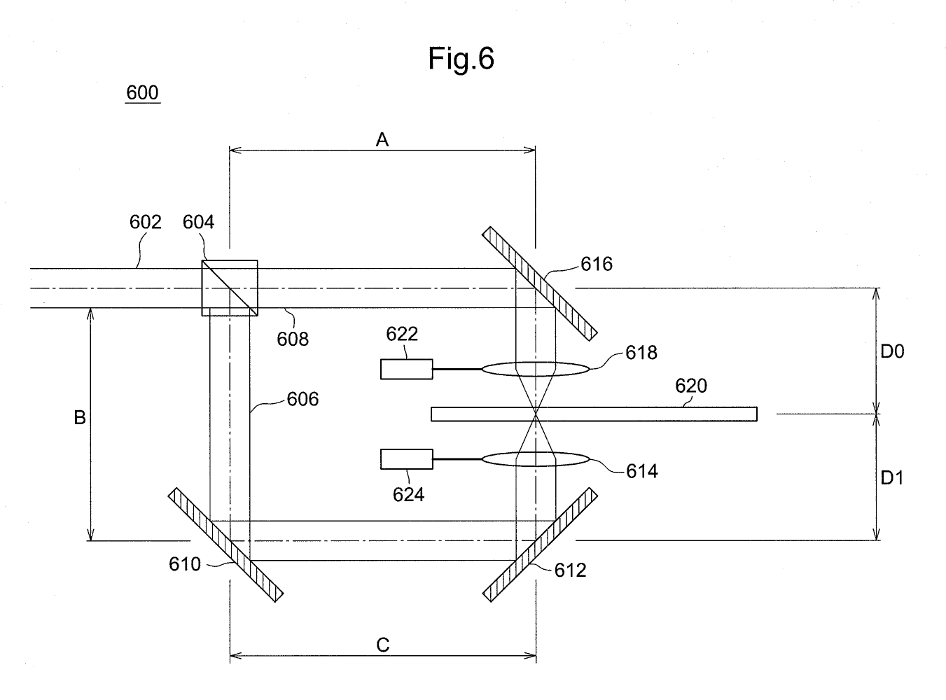

Referring to FIGS. 5-6, an optical system for reading and recording data on a media according to an exemplary embodiment will be discussed. A bit-by-bit recording media associated with a holographic architecture in which the beams travel in opposite directions, or volume holography in which the beams travel in the same direction or at a certain angle can be used.

Referring to FIG. 5, an exemplary laser source for the optical system will be discussed. In this embodiment, the laser source is an external cavity laser 500 which includes a laser diode 502 such as, for example, a semiconductor blue laser diode for generating a multimode laser beam 504, a collimator lens 506 which converts the divergent light of the laser beam 504 into collimated light 508, and a grating 510 capable of diffracting the incoming light over a finite number of discrete angles and partially reflecting back only the selected laser line thus producing single mode light 512. Alternatively, the laser source can be merely the laser diode 502 and collimator lens 506 for generating the multimode light. The laser source is not limited to the semiconductor blue laser diode. Alternatively, the laser source can include semiconductor laser diodes of any wavelength.

Referring to FIG. 6, an optical subsystem 600 for the optical system according to the exemplary embodiment will be discussed. Incoming laser light 602, which may be multimode or single mode, is split by a beam splitter 604 into a reference beam 606 and an object beam 608. The beam splitter 604 may be, for example a polarization insensitive 50:50 beam splitter. A first mirror 610 reflects the reference beam 606 towards a second mirror 612, which reflects the reference beam 606 to a first objective lens 614. A third mirror 616 reflects the object beam 608 to a second objective lens 618. The first and second objective lens 614, 618 respectively focus the reference and object beams at a focal point on the media 620 at which the reference beam 606 and object beam 608 interfere with each other. The first and second lens 614, 618 can be coupled to first and second actuators 622, 624, which are configured to independently move the lens to focus on a correct layer inside the media 620 by, for example, a controlling device such as a processor.

The reference beam 606 and the object beam 608 have first and second optical path lengths defined from the laser source to the focal point of the media. For example, excluding the path between the laser source and the beam splitter 604, the path of the object beam 608 is A+D0 and the path of the reference beam 606 is B+C+D1. Generally, the optical subsystem 600 is positioned so that an optical path length difference between the first and second optical path lengths is substantially equal to an integer multiple of an interference revival period associated with the reference beam 606 and the object beam 608. As discussed above, the interference revival period is associated with the constant steps of peak values of visibility of the interference versus the optical path difference.

Assuming that the laser source is merely the laser diode 502 and collimator lens 506 for generating the multi-mode light, the interference revival period will be equal to 2nL, wherein n is the refraction index of the diode material and L is the length of the diode. For a Blu-ray laser diode, the interference revival period is approximately 4260 micrometers as shown in FIG. 4. In this case, the path difference should be approximately either 4260 micrometers, an integer multiple of 4260 micrometers or zero.

Assuming that the laser source is the external cavity laser 500 such as the external cavity laser 500 shown in FIG. 5, the interference revival period will equal n1*L1+L2+n2*L3+L4, wherein n1 is the refraction index of the diode material, n2 is the refraction index of the collimator lens, L1 is the length of the diode material, L2 is the distance between the laser facet and the lens first surface, L3 is the thickness of the collimator lens 506, and L4 is the distance between the lens second surface and the grating 510. For an exemplary external cavity laser, the interference revival period is 36.55 mm as shown in FIG. 12.

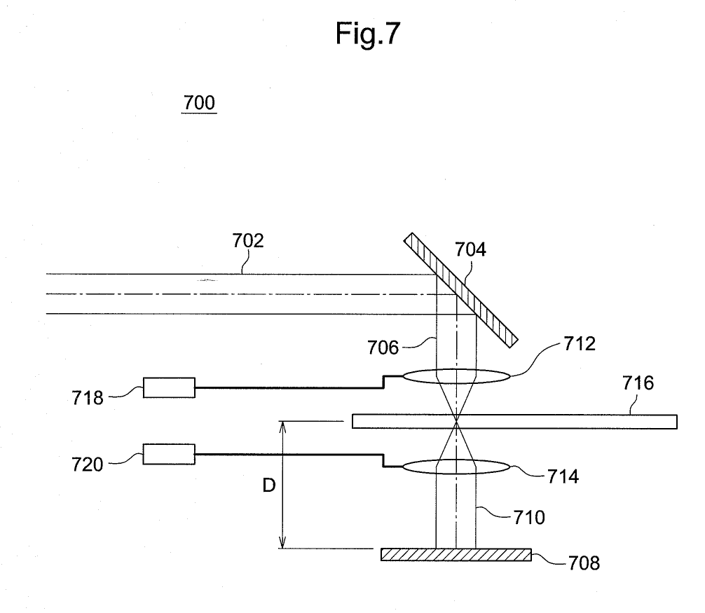

Referring to FIG. 7, an optical subsystem 700 for the optical system according to another exemplary embodiment will be discussed. Incoming laser light 702, which may be multimode or single mode, is reflected by a first mirror 704. The reflected light from the first mirror 704 can be the reference beam 706. The reference beam 706 passes through a first lens 712 and is focused at a focal point on the media 716. The reference beam 706 passes through the media 716 and a second lens 714 to a second mirror 708, and is reflected back by the second mirror 708 to form the object beam 710. The first and second lens 712, 714 respectively focus the reference and object beams at a focal point on the media 716 at which the reference and object beams interfere with each other to create microholograms. The microholograms previously written can be read by, for example, directing only the reference beam 706 at the focal point while blocking the object beam 710. The first and second lens 712, 714 can be coupled to first and second actuators 718, 720, which are configured to independently move the lens to focus on a correct layer inside the media 716 by, for example, a controlling device such as a processor.

Similarly to the optical system 600, the reference beam 706 and the object beam 710 have first and second optical path lengths defined from the laser source to the focal point of the media. The path lengths of the reference and object beams 706, 710 are common up to the focal point inside the media 716. However, a path difference between the two beams is present from the focal point of the media 716 to the second mirror 708 and back to the focal point of the media 716. Thus, the optical path length difference is equal to 2D, wherein D is the distance between the second mirror 708 and the focal point of the media 716. The second mirror 708 is preferably disposed a predetermined distance D from the focal point so that the optical path length difference between the first and second optical path lengths is substantially equal to the integer multiple of the interference revival period. For example, if the distance D from the focal point to the surface of the second mirror 708 is an integer multiplier of the interference revival half-period, preferably one half of the revival period, the optical path difference will be an integer multiple of the interference revival period. This will allow even in this architecture with an intrinsic unavoidable path difference the use of a system with short coherence.

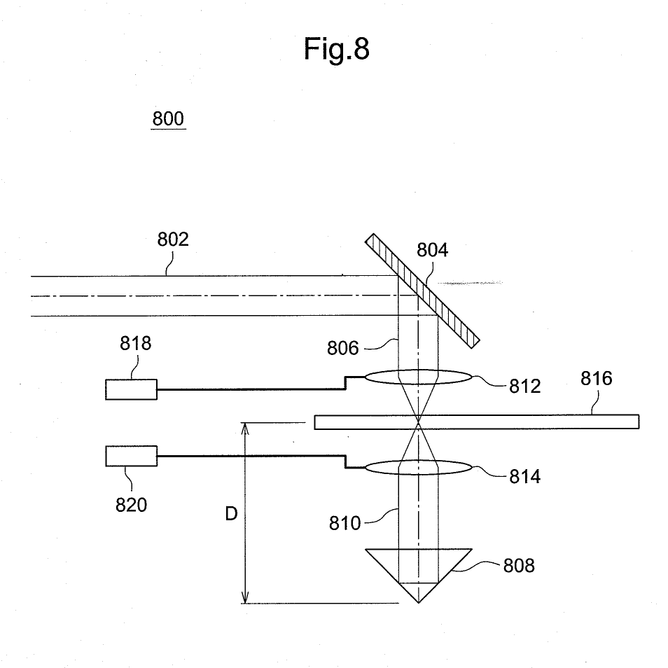

Referring to FIG. 8, an optical subsystem 800 for the optical system according to another exemplary embodiment will be discussed. Incoming laser light 802, which may be multimode or single mode light is reflected by a first mirror 804. The reflected light from the first mirror 804 can be the reference beam 806. The reference beam 806 is reflected back by a retroreflector 808 to form the object beam 810. First and second lens 812, 814 respectively focus the reference and object beams at a focal point on the media 816 at which the reference and object beams interfere with each other. The first and second lens 812, 814 are coupled to first and second actuators 818, 820. The actuators 818, 820 can be configured to independently move the lens to focus on a correct layer inside the media 816 by, for example, a controlling device such as a processor.

Similarly to the second mirror 708 of the above embodiment, the retroreflector 808 is disposed a predetermined distance from the focal point so that the optical path length difference is substantially equal to the integer multiple of the interference revival period. For example, the distance D from the focal point to the retroreflector 808 can exactly match an integer multiplier of the interference revival half-period, preferably one half of the revival period.

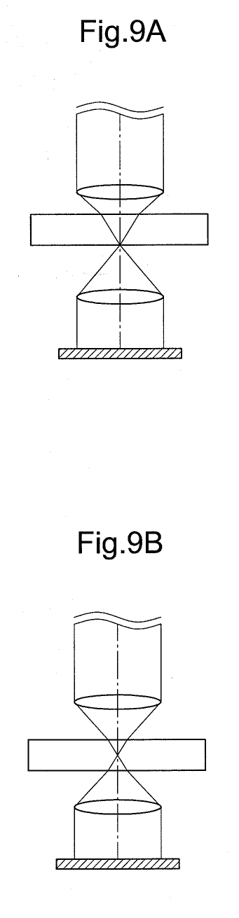

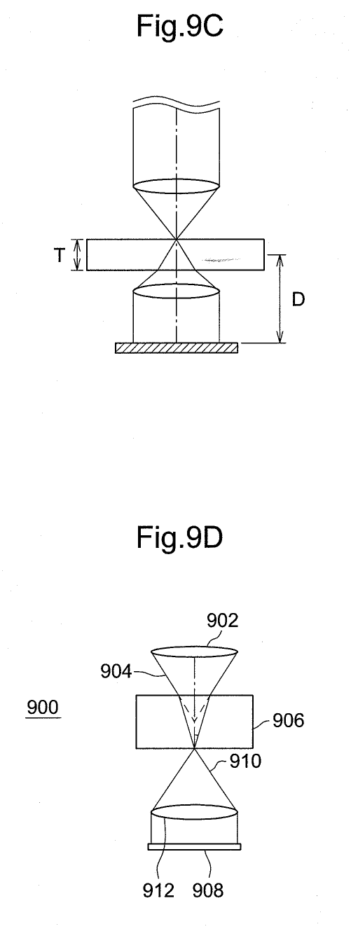

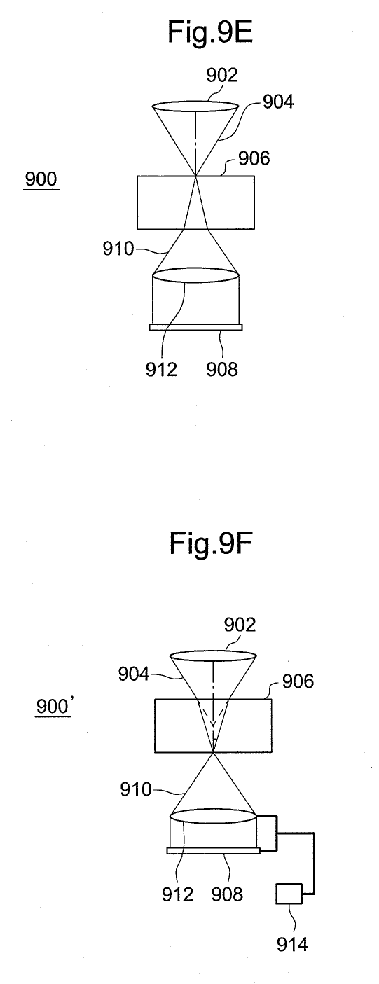

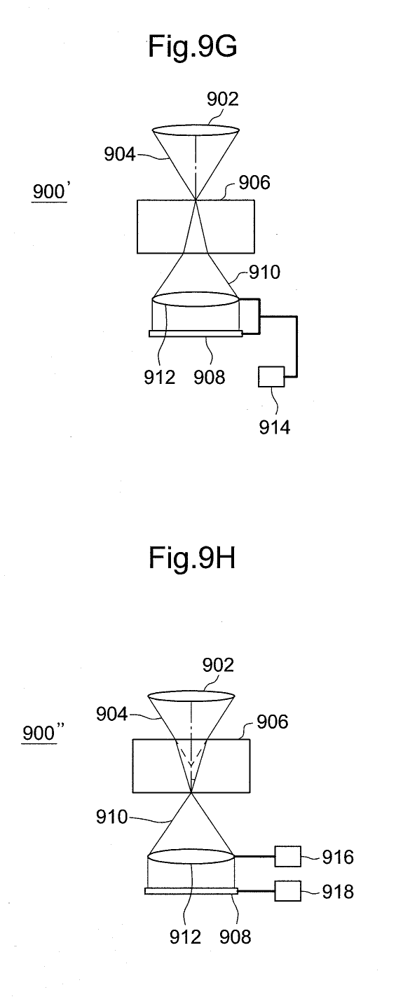

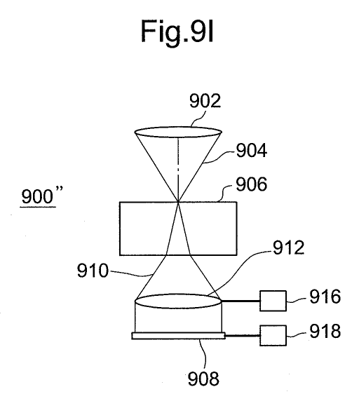

Generally, as discussed above, the optical subsystem according to the above embodiments is positioned so that an optical path length difference between the first and second optical path lengths is substantially equal to an integer multiple of an interference revival period associated with the reference and object beams. However, a certain coherence length may still be needed to compensate for a variable optical path difference (Pvar) relevant to the many writing layers of the media. The variable optical path difference which occurs along with movement of the lens and optical element of the optical system is illustrated in FIGS. 9A-9C. First and second lens respectively focus a reference beam and an object beam reflected from a mirror or retroreflector (optical element) at a focal point on the media. FIGS. 9A-9C illustrate the focal point on a lower layer, middle layer and upper layer of the media. In a most extreme case (FIG. 9C), the variable optical path difference (Pvar) will be equal to 2nT, wherein n is the refraction index of the media and T is the thickness of the media.

The optical system can sufficiently read or write to all layers of the media as long as the PCL of the revival peak is greater than Pvar for the most extreme case. Such an optical system is illustrated in FIGS. 9D-9E. The optical system 900 includes a first objective lens 902 for focusing the reference beam 904 on a focal point of the media 906. An optical element 908, which is preferably a mirror or retroreflector, reflects an object beam 910 onto a second objective lens 912, which focus the object beam 910 on a focal point of the media 906. As shown in FIG. 9E, the first and second objective lens 902, 912 move to focus the object beam 910 on a different layer of the media 906. The maximum travel (Δ) of the lenses is linked to the numerical aperture (NA) of the lenses themselves, the thickness (Y) of the media 906, and the refraction index (n) of the holographic media 906 by the following formula: Formula 1

$$Δ = T \frac{tan ( arcsin ( \frac{N A}{n} ) )}{tan ( arcsin ( N A ) )} .$$

First and second actuators (not shown) can be configured to control the motion of the first and second objective lens 902, 912. The Pvar for the most extreme case will be equal to 2nT. In this case, the revival peak of the beams 904, 910 can be greater than Pvar for the most extreme case.

According to another embodiment of an optical system illustrated in FIGS. 9F-9G, the variable optical path difference Pvar for the most extreme case can be reduced. In the optical system 900′, an actuator 914 is coupled to the optical element 908. The actuator 914 can be configured to move the optical element 908 together with the second objective lens 912 up to a certain distance Δ. In this case, Pvar is decreased according to Formula 2: Pᵥₐᵣ=2[nT−Δ], wherein Δ is the max travel distance of the second objective lens 912. Preferably, the actuator 914 can be the same actuator used to move the objective lens 912. Motion of the object lens 912 and the optical element 908 is shown in FIG. 9G.

However, moving together the optical element 908 and the second objective lens may not be sufficient for reducing Pvar to be less than the PCL when, for example, the laser source is the bare laser diode due to its small PCL. However, according to another embodiment illustrated in FIGS. 9H-9I, the optical system 900″ includes first and second actuators 916, 918 configured to independently move the second objective lens 912 and the optical element 908 to achieve a variable optical path difference of zero. For example, the second actuator 918 can be configured to move the optical element 908 up to a distance 2nT depending on the focus layer inside the media to achieve zero Pvar.

Generally, an optical system including the external cavity laser as the laser source may provide laser light with a PCL sufficient so that the configuration of optical system 900 or 900′ can be used. If a bare laser diode is the laser source, then the configuration of optical system 900″ may be needed.

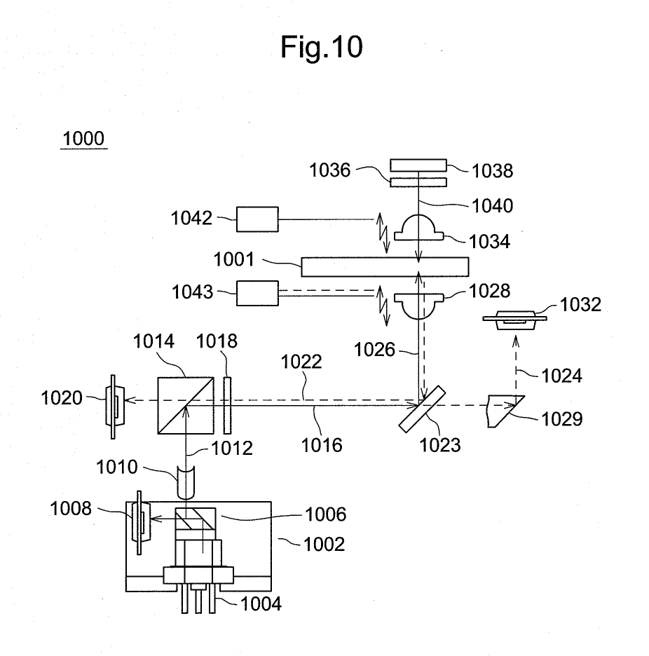

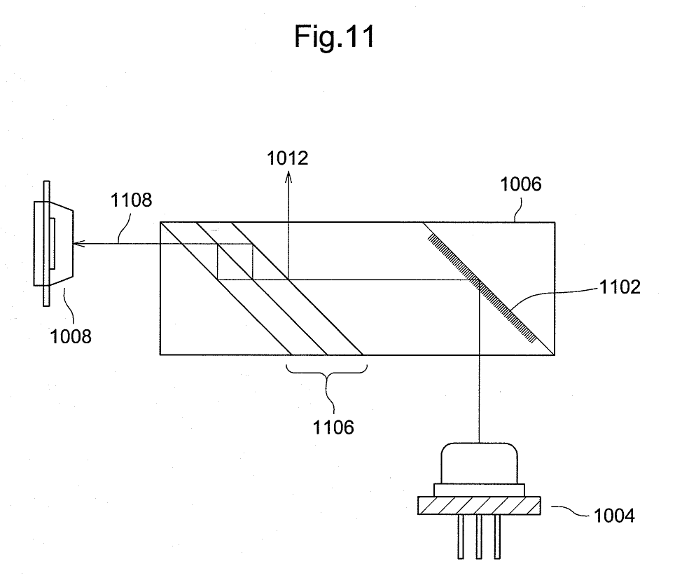

Referring to FIGS. 10-11, an optical system 1000 according to another exemplary embodiment for reading and writing data to a holographic media 1001 will be discussed. The optical system 1000 includes an external cavity laser 1002 as a laser source for generating a laser beam. The external cavity laser 1002 includes a laser diode 1004 for generating multimode light, a laminated prism 1006 and a visibility monitor 1008. As shown in FIG. 11, the laminated prism 1006 includes an integrated grating 1102 for generating single mode light, and an interferometer 1106 for generating interfering beams 1108 which are received at the visibility monitor 1008. The interferometer 1106 can be, for example, a Mach Zender interferometer which includes three half mirrors and regions with different refraction indexes. The refraction index of these regions can be designed in order to create an optical path difference between the two arms of the interferometer equal to the max optical path difference between object and reading beams inside the media (the optical path difference in the worst case). The visibility monitor 1008 will thus measure the worst case visibility. The interferometer 1106 also reflects the laser light to generate the external cavity laser output.

Returning to FIG. 10, the optical system 1000 includes a collimator lens 1010 for generating a collimated laser beam 1012. A polarization beam splitter 1014 and quarter waveplate 1018 act as an optical isolator for changing vertically polarized light from the laser source into circular polarized light 1016 to be deflected toward the rest of the optical system and changing light 1022 reflected back from the media 1001 into horizontal polarization to be transmitted to the reading sensor 1020, which receives the image of the microholograms in the media when the media is read.

A half transparent mirror 1023 reflects a first portion 1026 of the laser beam 1016, which is the reference beam, towards a first objective lens 1028 and a second portion 1024 towards an optical element 1029, which focuses the second portion 1024 of the laser beam into a power monitor 1032 for measuring the beam power level.

The reference beam 1026 passes through the first objective lens 1028, which focuses it at a focal point on the media 1001. The reference beam 1026 passes through the media 1001, a second objective lens 1034 and a shutter 1036, and is reflected back by a mirror 1038 to form an object beam 1040. The first and second lens 1028, 1034 respectively focus the reference and object beams 1026, 1040 at the focal point on the media 1001 at which the beams interfere with each other to create microholograms. The microholograms previously written can be read by, for example, directing only the reference beam 1026 at the focal point while activating the shutter 1036 to block the object beam 1040. The first and second lens 1028, 1034 can be coupled to actuators 1042, 1043, which can be configured to independently move the lens to focus on a correct layer inside the media 1001. Alternatively a single actuator can move both objective lenses together. A controlling device such as a processor (not shown) can control the actuators 1042, 1043. Further, similarly to the various embodiments illustrated in FIGS. 9D-9I, the actuator 1043 can be configured to move the mirror 1038 together with the lens 1034, or the other actuator 1044 can independently control the mirror 1038 to reduce or eliminate the variable path difference.

The reference beam 1026 and the object beam 1040 have first and second optical path lengths defined from the external cavity laser 1002 to the focal point of the media 1001. The optical subsystem is positioned so that an optical path length difference between the first and second optical path lengths is substantially equal to an integer multiple of an interference revival period associated with the reference beam 1026 and the object beam 1040, the interference revival period associated with peak values of visibility of the interference versus the optical path difference. Generally, the path difference will be substantially equal to twice the path from the focal point of the media 1001 to the mirror 1038.

As shown in FIG. 12, the exemplary external cavity laser 1002 of the optical system 1000 has an interference revival period of approximately 36.55 mm and a PCL of approximately 3.3 mm in dual mode operation (1204). Accordingly, the distance between the focal point of the media 1001 and the mirror 1038 can be an integer multiple of 36.55/2=18.275 mm for this particular exemplary configuration. The PCL is greater in single mode operation (1202).

Therefore, the present disclosure concerns an optical system for reading and recording data on a media. According to an embodiment, the system can include: a laser source for generating a laser beam; an optical subsystem for splitting the laser beam into a reference beam and an object beam; and first and second lens for receiving the reference and object beams, respectively, and focusing the reference and object beams at a focal point on the media at which the reference beam and object beam interfere with each other. The reference beam and object beam have first and second optical path lengths defined from the laser source to the focal point of the media. The optical subsystem is positioned so that an optical path length difference between the first and second optical path lengths is substantially equal to an integer multiple of an interference revival period associated with the reference beam and the object beam.

Other embodiments of the optical system will be apparent to those skilled in the art from consideration of the specification and practice of the optical system as disclosed herein. For example, the subsystem can include a tracking system to ensure the proper positioning of the objective lenses and the optical elements. Further, the system can include computer code for configuring the processor to adjust the lens and optical elements based upon data related to the interference revival period. It is intended that the specification and examples be considered as exemplary only, with a true scope and spirit of the invention being indicated by the following claims.

1. An optical system for reading and recording data on a media, comprising:
a laser source for generating a laser beam;
an optical subsystem for splitting the laser beam into a reference beam and an object beam; and
a first lens and a second lens for receiving the reference beam and the object beam, respectively, and focusing the reference beam and object beam at a focal point on the media at which the reference beam and object beam interfere with each other;
wherein the reference beam and the object beam have first and second optical path lengths defined from the laser source to the focal point of the media;
wherein the optical subsystem is positioned so that an optical path length difference between the first and second optical path lengths is substantially equal to an integer multiple of an interference revival period associated with the reference beam and the object beam.

2. The optical system of claim 1, wherein the interference revival period is associated with peak values of visibility of the interference versus the optical path difference.

3. The optical system of claim 1, wherein the laser source is a semiconductor laser diode generating a multimode laser beam.

4. The optical system of claim 1, wherein the optical subsystem comprises:
an optical element for reflecting one of the reference and object beams onto one of the first and second lens; and
an actuator coupled to one of the first and second lens, the actuator configured to move the one of the first and second lens to thereby focus the beam inside the media.

5. The optical system of claim 1, wherein the optical subsystem comprises:
an optical element for reflecting the object beam onto the second lens; and
an actuator coupled to the second lens and the optical element, the actuator configured to move the second lens to thereby focus the beam inside the media and to also simultaneously move the second lens and the optical element to thereby reduce the optical path length difference.

6. The optical system of claim 1, wherein the optical subsystem comprises:
an optical element for reflecting the object beam onto the second lens;
a first actuator coupled to the optical element; and
a second actuator coupled to the second lens,
wherein the first and second actuators are configured to independently move the optical element and the second lens to thereby maintain the optical path length difference.

7. The optical system of claim 1, wherein the optical subsystem comprises:
a beam splitter for splitting the laser beam into the reference beam and the object beam;
a first mirror and a second mirror for reflecting the reference beam onto the first lens; and
a third mirror for reflecting the object beam onto the second lens,
wherein the first and second mirrors are disposed a predetermined distance from the focal point so that the optical path length difference is substantially equal to the integer multiple of the interference revival period.

8. The optical system of claim 1, wherein the optical subsystem comprises:
a first mirror for reflecting the reference beam onto the first lens; and
a second mirror for reflecting the object beam onto the second lens,
wherein the second mirror is disposed a predetermined distance from the focal point so that the optical path length difference is substantially equal to the integer multiple of the interference revival period.

9. The optical system of claim 8, further comprising:
an actuator coupled to the second mirror and the second lens, the actuator configured to simultaneously move the second lens and the second mirror to thereby compensate for a variable optical path length difference.

10. The optical system of claim 8, further comprising:
a first actuator coupled to the second mirror; and
a second actuator coupled to the second lens,
wherein the first and second actuators are configured to independently move the second mirror and the second lens to thereby compensate for a variable optical path length difference.

11. The optical system of claim 1, wherein the optical subsystem includes:
a first mirror for reflecting the reference beam onto the first lens; and
a retroreflector for reflecting the object beam onto the second lens, the retroreflector disposed a predetermined distance from the focal point so that the optical path length difference is substantially equal to the integer multiple of the interference revival period.

12. The optical system of claim 11, further comprising:
an actuator coupled to the retroreflector and the second lens, the actuator configured to simultaneously move the second lens and the retroreflector to thereby compensate for a variable optical path length difference.

13. The optical system of claim 11, further comprising:
a first actuator coupled to the retroreflector; and
a second actuator coupled to the second lens,
wherein the first and second actuators are configured to independently move the retroreflector and the second lens to thereby compensate for a variable optical path length difference.

14. The optical system of claim 1, wherein the laser source is an external cavity laser including a laser diode for generating a multimode laser beam and a grating for outputting a single mode of the light associated with the laser beam.

15. The optical system of claim 1, wherein the laser source is an external cavity laser including:
a laser diode for generating a multimode laser beam;
a grating configured to select laser light of a single mode associated with the laser beam;
an interferometer for generating interfering beams and the laser beam; and
a visibility monitor for monitoring a visibility property of the interfering beams.

16. A method for recording holographic data on a media, comprising:
generating a laser beam;
splitting the laser beam into a reference beam and an object beam;
reflecting the reference beam toward a first lens disposed on one side of the media to focus the reference beam at a focal point of the media at which the reference beam and object beam interfere with each other;
reflecting the object beam toward a second lens disposed on an opposite side of the media to focus the object beam at the focal point of the media,
wherein the reference beam and the object beam have first and second optical path lengths defined from a laser source at which the laser beam is generated to the focal point of the media;
wherein the reflecting of the object beam further includes reflecting the object beam at a predetermined position so that an optical path length difference between the first and second optical path lengths is substantially equal to an integer multiple of an interference revival period associated with the reference beam and the object beam, the interference revival period associated with peak values of visibility of the interference versus the optical path difference.

17. The method of claim 16, wherein the generating of the laser beam further includes generating multimode laser light and selecting a single mode of the multimode laser light at a predetermined cavity length from the laser source, wherein the predetermined cavity length is proportional to the interference revival period.

18. The method of claim 16, further comprising adjusting a position of the second lens and the predetermined position at which the object beam is reflected by a certain distance in order to compensate for a variable optical path length difference.

19. The method of claim 16, further comprising independently adjusting a position of the second lens and the predetermined position at which the object beam is reflected to thereby compensate for a variable optical path length difference.
